(19) United States
(12) Patent Application Publication
(10) Pub. No.: US 2007/0061176 A1
(43) Pub. Date: Mar. 15, 2007

(54) System and method for analysis and display of workflows

(76) Inventors: Manfred Gress, Herzogenaurach (DE); Ralf Russ, Munchen (DE); Rudolf Zeller, Neumarkt (DE)

Correspondence Address: BRINKS HOFER GILSON & LIONE, P.O. BOX 10395, CHICAGO, IL, 60610, US

(21) Appl. No.: 11/225,252

(22) Filed: Sep. 13, 2005

(51) Int. Cl. G06F 17/50

(52) U.S. Cl. 705/7

(57) ABSTRACT

The disclosed embodiments relate to the modeling of complex workflows, such as the workflows found in a clinical medical environment. The disclosed embodiments model clinical medical workflows using Activities, Artifacts and Roles as the fundamental elements wherein the relationship among the elements defines the model. By use of the disclosed pattern (activity-role-artifact), a complex real problem may be copied on to an easily manipulated (in Excel) model. In this model, incomplete information as well as inconsistencies and procedures that are “unfavorable” (such as because they are nested) are identified. By using macros and by graphic processing, workflows that “require untangling”, or other optimization, are readily detected. This review process leads to an improvement of the model and finally of the procedures in the doctor's office. The thus-modeled and optimized procedures may then be converted and displayed using the HTML standard, such as in a standard browser (such as Microsoft Internet Explorer).

### REFERENCE TO RELATED APPLICATIONS

The following co-pending and commonly assigned U.S. Patent Application has been filed on the same date as the present application. This application relates to and further describes other aspects of the embodiments disclosed in the present application and is herein incorporated by reference.

U.S. patent application Ser. No.______, “SYSTEM AND METHOD FOR CONVERTING COMPLEX DATABASE STRUCTURES TO HTML”, (Attorney Ref. No. 11371/74), filed herewith, now U.S. Pat. No. ______.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Clinical medical environments, such as medical clinics, hospitals, or doctor's offices, are complex operations involving multiple, and oftentimes intertwined or co-dependent, workflows. A workflow is defined as the activities, e.g. tasks or procedural steps, entities involved, i.e. actors or participants, such as people, organizations, machines, etc., inputs and outputs, states, requisite tools, and the relationships therebetween, for each step in a process. The various activities, entities, inputs, outputs, tools and relationships which make up a particular workflow are referred to as workflow elements. A workflow may include multiple intertwined, co-dependent or independent sub-workflows. For example, a typical hospital may implement workflows for staff scheduling, accounting, regulatory compliance, patient intake, patient examinations, record keeping, inventory control, etc.

It is often difficult to represent these workflows in an abstract manner for the purposes of presentation, review and/or analysis, such as to identify inconsistencies in a workflow or analyze workflow efficiency or effectiveness, due to the inability to view the particular workflow's internal structures/elements or relationships/dynamics therebetween on an ad hoc basis, i.e. for a particular purpose. Such analysis is further complicated when multiple workflows are intertwined or depend upon each other and/or other workflows. Further, the clinical medical environment is further complicated by the degree to which the workflow elements consist of, or are based on, human decision making, human judgment, human-to-human interaction, or other subjective, arbitrary or illogical bases which may not be easily captured, analyzed or modified in an objective manner. As a consequence, these workflows often remain inefficiently implemented, redundant, or otherwise sub-optimal.

Accordingly, there is a need for system and method to develop, analyze, refine, optimize and maintain such complex workflows.

### BRIEF DESCRIPTION OF THE DRAWINGS

FIG. 1 depicts a flow chart depicting a method of modeling a workflow according to one embodiment.

FIG. 2 depicts a block diagram of a system for modeling a workflow according to the embodiment of FIG. 1.

FIGS. 3-7 depict an exemplary model of a clinical medical workflow, according to the embodiment of FIG. 1.

### DETAILED DESCRIPTION OF THE DRAWINGS AND PRESENTLY PREFERRED EMBODIMENTS

The disclosed embodiments relate to the modeling of complex workflows, such as the workflows found in a clinical medical environment. Exemplary clinical medical environments include hospital's, doctor's offices, medical clinics, urgent care facilities, hospice's, home care environments, triage facilities, research clinics, ambulatory environments and other environments in which medical professionals, such as doctors, nurses, medical technicians, etc., care for the health of patients. In particular, the disclosed embodiments utilize principles derived from the business of computer software development to develop, analyze, refine, optimize and maintain complex clinical medical environment workflows.

As used herein, a workflow is defined as the activities, e.g. tasks or procedural steps, entities involved, i.e. actors or participants, such as people, organizations, machines, etc., inputs and outputs, states, requisite tools, and the relationships therebetween, for each step in a process. The various activities, entities, inputs, outputs, tools and relationships which make up the workflow are referred to as workflow elements. While computers and computer programs may be included as workflow elements, the disclosed embodiments are directed to workflows which further include workflow elements involving human decision making, human judgment, human-to-human interaction, or other subjective, arbitrary or illogical bases. These are often complex workflows whose internal structure and dynamics cannot be looked into ad hoc, i.e. for a particular/specific purpose. As such, developing, analyzing, optimizing and/or maintaining such workflows is difficult.

The disclosed embodiments provide a system and method for modeling and representing such workflows, abstractly or otherwise, so that they may objectively developed, analyzed, optimized and/or maintained. This results in a clinical medical setting which is more efficiently operated, e.g. resources are efficiently utilized and standards of care are maintained. In addition, the disclosed embodiments provide for a simpler and more effective insight into particular workflows, such as particular medical procedures, an objective basis upon which to discuss and improve workflows, as well as a simplified workflow representation which aids in presentation and discussion. Further, the disclosed embodiments permit simplified integration of new workflows or workflow elements with current workflows, such as integration of new medical procedures or new equipment or technology. In addition, the disclosed embodiments allow complex workflows to be analyzed to determine any inter- or co-dependencies, allowing co-dependent workflows to be separated and isolated from each other, e.g. untangled, or particular workflow elements to be removed, such as when a procedure or technology is phased out.

While the disclosed embodiments are directed to a static representation of a workflow(s), it will be appreciated that a dynamic representation may also be used, for example to simulate workflow flow and operation.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

Exemplary workflows found in a clinical medical environment include office management related procedures such as staff scheduling, appointment scheduling, accounting, billing, collections, payroll, medical insurance billing and reimbursement, management of office operating expenses, patient medical records management, inventory management, business development, marketing, customer retention management, facilities maintenance, medical and administrative staff training, regulatory compliance (licensing, continuing education, waste disposal, hazardous materials, privacy, safety), patient and staff security and safety, etc. Other exemplary clinical medical workflows include patient management/interaction/care workflows, such as patient registration, in-take and out-take, medical procedures/tests (imaging, diagnostic, etc.), examinations, diagnosis (differential diagnosis (A list of possible diseases that fit the information derived from examination of a patient)), treatment administration, interactions with staff, education (preventive care, present diagnosis, treatment options, drug interactions), patient experience, in-bound and out-bound referrals/transfers and hospital admissions, prescribing and/or dispensing pharmaceuticals, house calls/home care, medical records handling, emergency procedures/urgent care, triage, etc. It will be appreciated that a given workflow may be composed of multiple component workflows, operating serially or in parallel with each other, each including further component workflows or workflow elements. Further, a given workflow may be related to a subsequent workflow such that the upon completion of the workflow, the subsequent workflow may be enacted, either conditionally or unconditionally.

Prior workflow analysis tools utilized text descriptions, simple graphics, or complex database solutions, such the Aris Platform for business process management, provided by IDS Scheer AG, Germany or the Rational Process Workbench developed by IBM, located in White Plains, N.Y., which require specialized know-how and infrastructure.

The disclosed system and method are based on the Model-View-Controller (“MVC”) pattern, typically utilized in relation to the Unified Modeling Language™ (“UML™”), promulgated by the Object Management Group, Inc., located in Needham, Mass., to separate the modeling of the domain, the presentations and the actions based on user input. In the MVC pattern, a Model is task oriented and manages behavior and data, responds to requests for information about its state (typically from a view), and responds to instructions to change state (typically from a controller). A View manages the display of information. A Controller interprets inputs received a via user interface and informs/instructs a model and/or view to change as appropriate.

The disclosed embodiments utilize the Software Engineering Process framework, developed by Siemens AG, Germany (referred to as “SEP++”) to model clinical medical workflows using Activities, Artifacts and Roles as the fundamental elements wherein the relationship among the elements defines the model. Activities are composed of actions. Each activity has a responsible role, i.e. is performed by one actor (the acting or responsible role) (but the actor may be a board: several roles/members), and both input and output artifacts. Exemplary activities include Register patient, Prepare patient registration, Examine patient, Make a diagnosis, Explain diagnosis, De-register patient, etc.

Artifacts are the results of, or inputs to, activities, e.g. the inputs or outputs. Artifacts are characterized by Attributes, such as the verification method, i.e. the specification of the method of review, if required, and/or a completion milestone which states for which phase transition(s) the reviewed artifact must be available. Exemplary artifacts include Patient data (collected as a result of an inquiry, examination, etc.), Referral to a hospital, Patient medical images, such as x-ray or MRI images, Referral to a ward, Bills for services, etc.

Roles include actors, contributors, authors, reviewers, and/or boards. An actor mainly carries out the activity, ensures it is performed as scheduled, and that problems with impact on the schedule are communicated as early as possible. An actor may be further responsible for quality of the output. There is always at least one actor per activity. Contributors actively participate in generating the output or act as an advisor. Reviewers participate in the review with the focus of finding errors. Authors generate artifacts. Boards are special case role comprised of several roles/members. A board may act as an actor, contributor or reviewer. Exemplary roles include Clinic employees, such as clinical, administrative or maintenance employees, medical assistants, medical doctors, patients, etc.

As described above, the model is the relationship among the fundamental elements and is constructed in an activities-centric manner wherein the primary classification elements include Activity Blocks and Disciplines.

The disclosed embodiments utilize the MS Excel spreadsheet computer program, published by Microsoft Corporation located in Redmond, Wash., as a tool for modeling and description (using Excel's graphics and macro functionality). Using Excel's workflow graphics capabilities, the workflow and associated elements may be represented using graphic constructs. In addition, correlation among the elements of a workflow is modeled on activities sheets. Further, hyperlinks are used to show relationships among individual elements and with external elements. Utilizing visual basic macros, consistency checks may be performed and further representations of the model may be generated, e.g. role-centered or artifact centered views. Procedures modeled using the disclosed embodiments may be displayed on a standard web browser program, such as Internet Explorer, published by Microsoft Corporation, located in Redmond, Wash.

By use of the disclosed pattern (activity-role-artifact), a complex real problem may be copied on to an easily manipulated (in Excel) model. In this model, incomplete information as well as inconsistencies and procedures that are “unfavorable” (such as because they are nested) are identified. By using macros and by graphic processing, workflows that “require untangling”, or other optimization, are readily detected. This review process leads to an improvement of the model and finally of the procedures in the doctor's office.

The thus-modeled and optimized procedures may then be converted and displayed using the HTML standard, such as in a standard browser (such as Microsoft Internet Explorer). The elements in the displayed graphics and tables are linked to one another (and if desired or required to the outside as well), and the model is thus “navigable”. The individual “views” furthermore offer different viewing angles on the simulated reality, for instance from the viewpoint of the procedures (workflows), from the viewpoint of a role (by way of the so-called role table), or from the viewpoint of the artifacts (with the aid of which interfaces, for instance, between various disciplines are modeled).

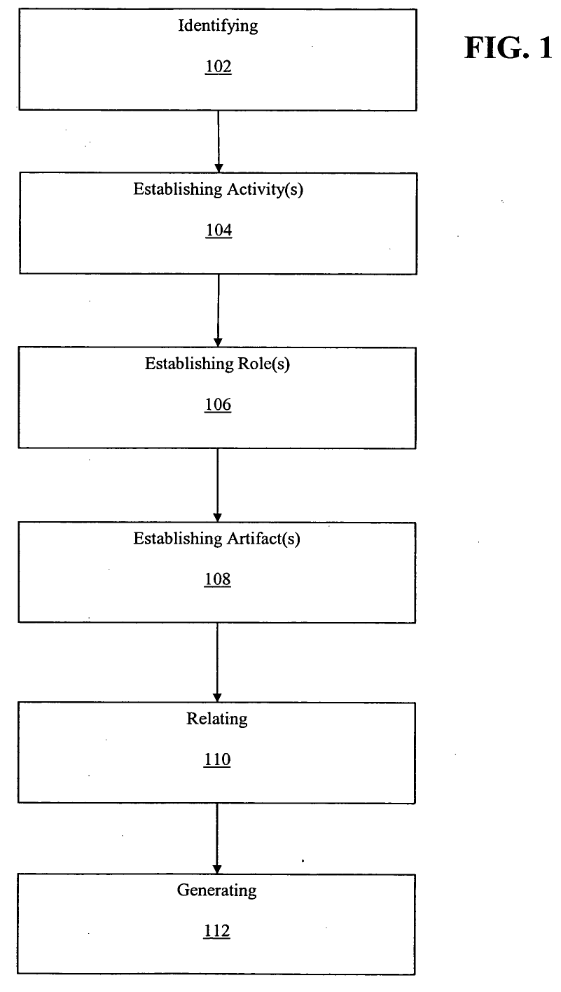

FIG. 1 shows a flow chart depicting operations of the disclosed method according to one embodiment. The depicted operations may be implemented in suitable computer logic, such as a computer program embodied in a computer readable medium, e.g. Microsoft Excel, which permits a user to identify the workflow elements of the clinic medical workflow to be modeled. The method of modeling a clinical medical workflow includes: identifying a plurality of workflow elements of the clinical medical workflow (block 102). In one embodiment, the clinical medical workflow comprises a medical procedure, or a portion thereof. The method further includes establishing at least one activity (block 104), at least one role (block 106) and at least one artifact (block 108), out of the plurality of workflow elements. The at least one activity may include at least one action performed by at least one role. The at least one role may include at least one entity that performs an action. The at least one artifact may include one of an output generated by at least one role performing at least one action or an input received by at least one role performing at least one action based thereon. The method further includes relating the at least one activity, the at least one role and the at least one artifact to define at least one relationship therebetween (block 110); and generating a model comprising a representation of the clinical medical workflow based on the at least one activity, the at least one role, the at least one artifact and the at least one relationship (block 112).

In an alternative embodiment, a visual representation of the model may be generated, the visual representation visually identifying the at least one activity, the at least one role, the at least one artifact, the at least one relationship, or combinations thereof. In particular, the visual representation may be generated by converting the model to Hypertext Markup Language (“HTML”) and rendering the HTML using a browser program such as Internet Explorer, published by Microsoft Corporation, located in Redmond, Wash. In another embodiment, the model may be analyzed to identify any inconsistencies or otherwise sub-optimal workflow elements of the clinical medical workflow. The model may then be optimized to correct any identified sub-optimal workflow elements, such as inconsistent, inefficient or redundant workflow elements or inter-workflow connections. In yet another embodiment, the model or visual representation thereof may be dynamic thereby facilitating simulation of the workflow, such as to identify inefficient relationships or interactions among workflow elements or between multiple workflows.

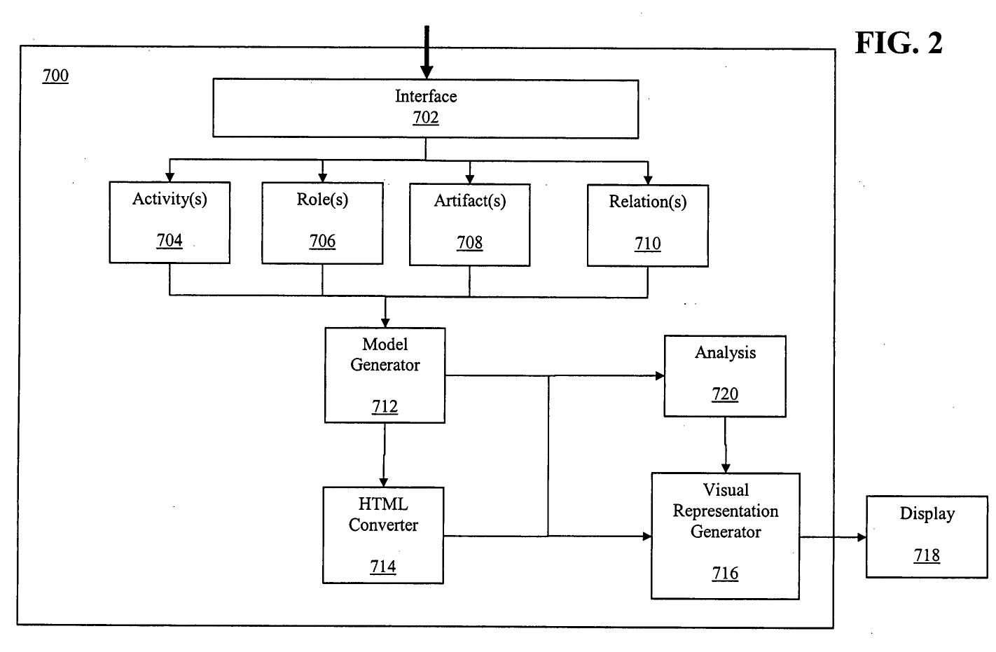

FIG. 2 depicts a block diagram of a system 700 for modeling a workflow according to the method describe above. The system 700 includes an interface 702, such as a graphic user interface or text based interface, for receiving identification of a plurality of workflow elements that make up one or more workflows to be modeled. In an alternate embodiment, the interface 702 is capable of interacting with other sources of workflow information such as databases or workflow automation or management software or hardware. The interface 702 is coupled with logic 704 706 708 710 which parses the workflow elements into one or more activities, roles, artifacts and the relationships therebetween. Herein, the phrase “coupled with” is defined to mean directly connected to or indirectly connected through one or more intermediate components. Such intermediate components may include both hardware and software based components. In one embodiment, the specification of workflow elements as activities, roles, artifacts, or the relationships therebetween, is provided by the user via the interface 702. In an alternate embodiment, the logic 704 706 708 710 automatically identifies which workflow elements are activities, roles, artifacts or the relationships therebetween. The logic 704 706 708 710 is further coupled with a model generator 712 which generates a model of the particular workflow(s) composed of the established activities, roles, artifacts and the relationships therebetween. In one embodiment, the interface 700, logic 704 706 708 710 and model generator 712 are all implemented using the graphic, macro and data processing functionality of Microsoft Excel, published by Microsoft Corporation, located in Redmond, Wash., and operating on any suitable computer platform capable of executing the Excel program. It will be appreciated, however, that the disclosed functionality, or portions thereof, may be implemented as a stand-alone system comprised of software, hardware or combinations thereof.

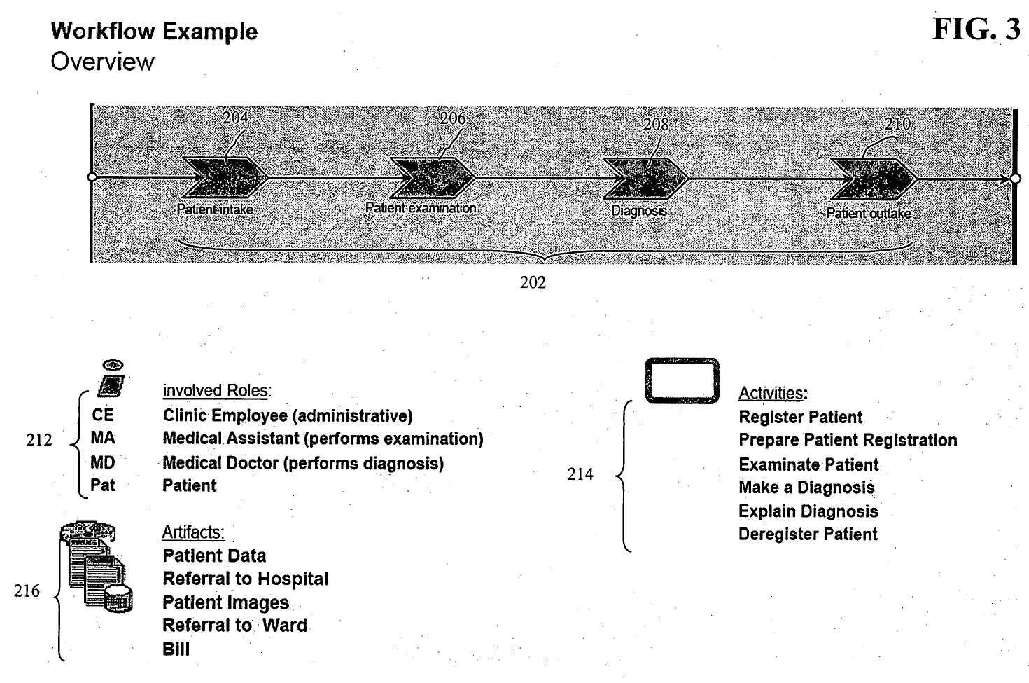

In an alternate embodiment, the model generator 712 is further coupled with an hypertext markup language (“HTML”) converter which is capable of converting the model to HTML code specifying a visual representation capable of being rendered on a display 718 by a visual representation generator 716 such as Internet Explorer, as shown for example in FIGS. 3-7. For more information, refer to U.S. patent application Ser. No. ______, “SYSTEM AND METHOD FOR CONVERTING COMPLEX DATABASE STRUCTURES TO HTML,” captioned above. The HTML converter is further capable of generating hyperlinks between the visually represented workflow elements as described below to create a user-navigable representation. Alternatively, a proprietary visual representation generator 716 may be used to generate a visual representation of the model on the display 718, as shown, for example in FIG. 3-7.

In another alternative embodiment, the model generator 712 is further coupled with analysis logic 720 which includes tools to analyze the model and identify sub-optimal characteristics/workflow elements, such as inefficiencies, redundancies or inconsistencies. Further, the analysis logic 720 may include tools to assist the user in correcting the identified sub-optimal workflow elements.

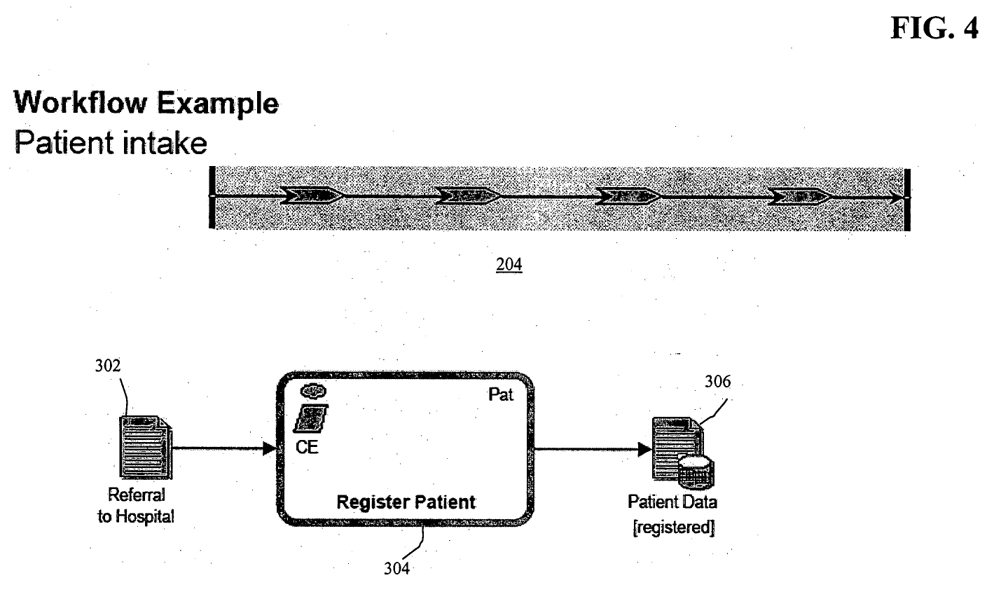

FIGS. 3-7 depict an exemplary model 202 of a clinical medical workflow, in particular the workflow for in-taking 204, examining 206, diagnosing 208 and out-taking 210 a patient in a clinical medical environment. Further, FIGS. 3-7 also depict an exemplary visual representation of the modeled exemplary workflow. It will be appreciated that the particular graphic constructs used to represent the workflow and the constituent workflow elements are implementation dependent and that any suitable graphic or text-based constructs may be utilized. FIG. 3 depicts the overall workflow 202 as well as identifies the involved roles 212, activities 214 and artifacts 216. In the visual representation of the workflow, one or more of the depicted graphical elements 202-216 may be hyperlinked to subsequent visual representations, such as those depicted in FIGS. 4-7, or portions thereof, allowing a user to easily navigate through the workflow for the purposes described herein.

FIG. 4 depicts the patient intake sub-workflow 204 of the workflow 202 of FIG. 3. The patient intake sub-workflow 204 includes the activity of registering the patient 304 which has an input artifact 302 being a referral and an output artifact 306 being the patient data once they have been registered, i.e. generated via the registration process. The output artifact may include the computer data record created to contain the patients medical information or may be a print out of the data or a portion thereof. In one embodiment, the patient registration activity 304 may include the collection of biographical and/or historical patient information as well as a medical history and/or assessment, such as via a patient interview, patient data sheet or electronic transfer of patient data from a referring entity. This information may be collected via an interview, performed by a staff member or self-completed.

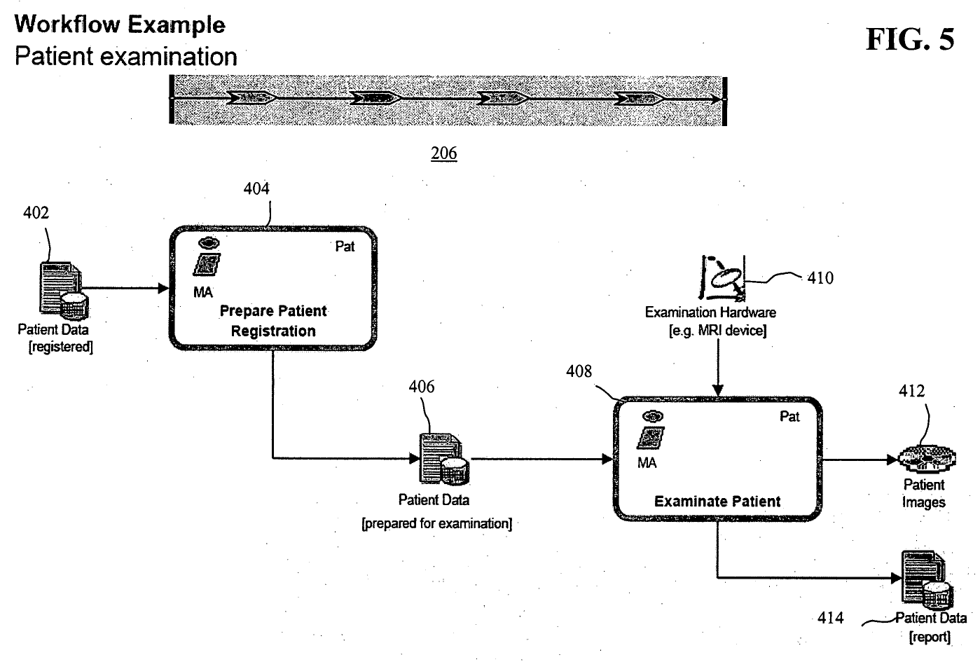

FIG. 5 depicts the patient examination sub-workflow 206 of the workflow 202 of FIG. 3. The patient examination sub-workflow 206 includes the activities of preparing patient registration 404 for the examination and examining the patient 408. In the depicted example, the examination includes the use of an imaging device, such as an MRI imaging device. The Preparing Patient Registration activity 404 includes a registered patient data artifact 402, such as the artifact 306, e.g. the patient data record or “chart”, generated in the patient intake sub-workflow 204. As described above, in one embodiment, the visual representation of the patient data artifact 402 may be hyperlinked to the visual representation of the patient data artifact 306 of FIG. 4. Alternatively, the patient data artifact 402 may have been generated during a previous visit by the patient. The Preparing Patient Registration activity 404 generates a patient data artifact 406 for use in the examination. For example, a sub-data-record maybe created to receive the results of the examination. The Examination activity 408 uses the patient data 406 and the examination hardware 410, such as the MRI device, and generates patient images 412 and/or other patient data 414, i.e. a report of the examination, such as vital signs, patient complaints, observations, etc. The patient images 412 artifact and/or the patient data (report) 414 artifact may be electronically generated or may be generated in hard copy such as an x-ray film, etc.

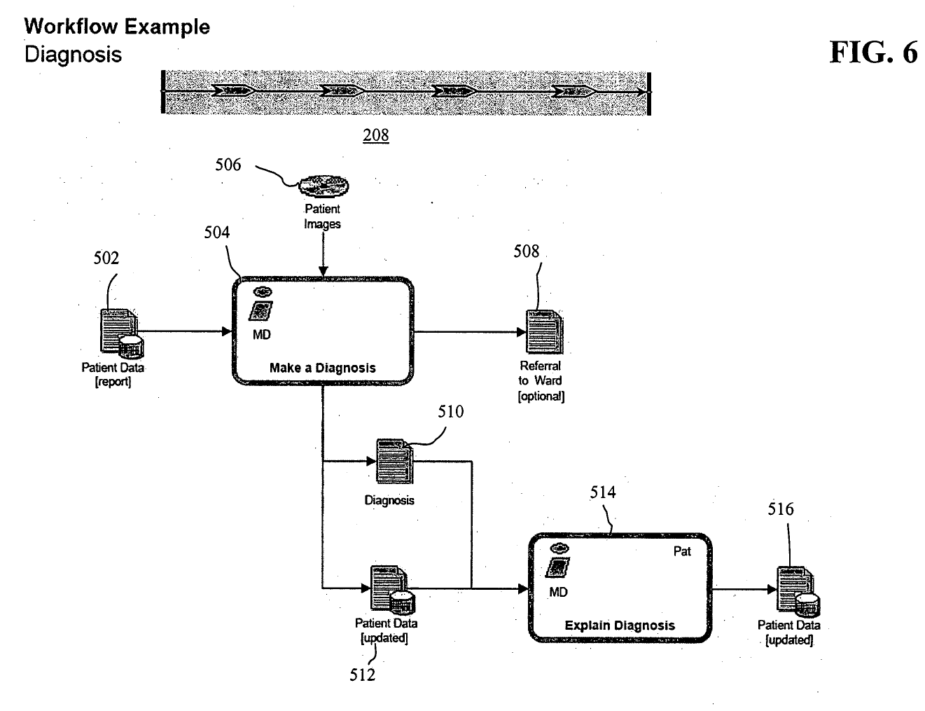

FIG. 6 depicts the diagnosis sub-workflow 208 of the workflow 202 of FIG. 3. The diagnosis sub-workflow 208 receives the patient data (report) 504 artifact and the patient images 506 artifact, presumably generated by, and in one embodiment, hyperlinked to, the patient data (report) 414 and patient images 412 of the patient examination workflow 206 depicted in FIG. 5. In an alternative embodiment, the patient data (report) and/or patient images 506 may have received from another source such as a referring physician seeking a consultation or second opinion. The diagnosis sub-workflow 208 further includes the activity of making a diagnosis 504 based on the patient data 502 and/or patient images 506. The activity 504 may then result in a diagnosis 510, referral 508 and/or updated patient data 512. For example, the diagnosis 510 and/or updated patient data 512 may include a differential diagnosis and final diagnosis of the patient's illness. A referral 508 may be generated where additional examination or tests are required or it is determined that specific care is required. The diagnosis sub-workflow 208 further includes the activity of explaining the diagnosis 514 which receives the diagnosis artifact 510 and the updated patient data artifact 512. The activity 514 may result in further updated patient data 516 which includes an explanation of the diagnosis, such as the basis, to either the referring medical practitioner or the patient.

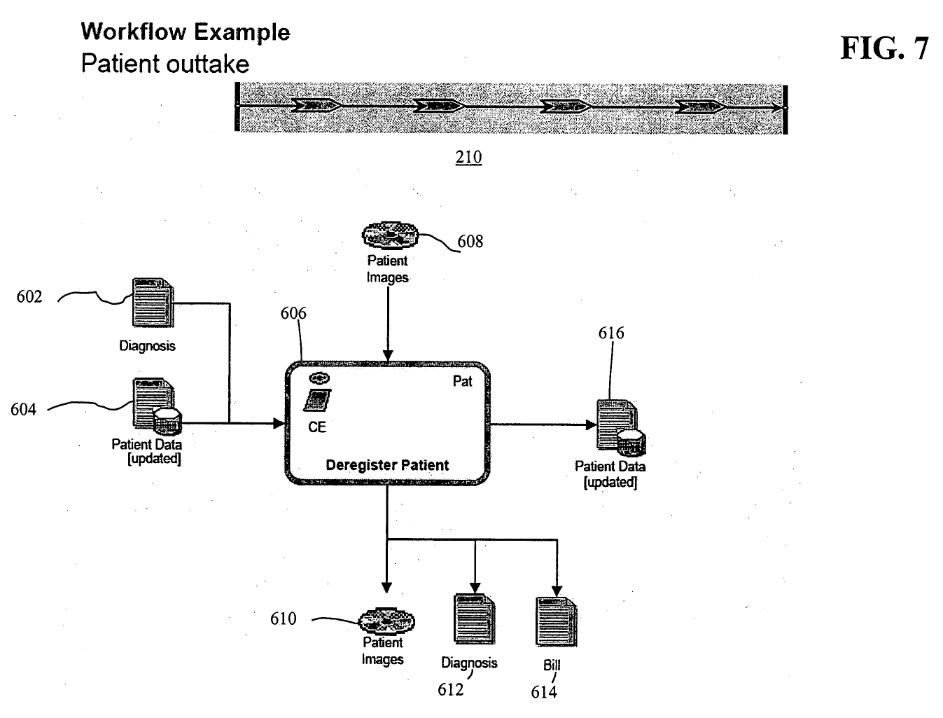

FIG. 7 depicts the patient out-take sub-workflow 210 of the workflow 202 of FIG. 3. The patient out-take sub-workflow 210 includes the activity of deregistering the patient 606 which includes processing the diagnosis artifact 602 and the updated patient data artifact 604 generated in the diagnosis sub-workflow 208, as well as the patient images 608 generated in the examination sub-workflow 206. As discussed, the visual representations of the diagnosis artifact 602, patient data 603 and patient images may be hyperlinked to the related visual representations elsewhere in the visually represented model. The activity 210 may simply comprise gathering all of the paperwork into a patient file folder or collecting or updating electronic records in an electronic patient management system/database. Further, the activity 606 may generate artifacts such as patient image 610, a diagnosis, or patient data, such as where the patient requests or requires a copy, and a bill, either to the patient, such as for a co-pay or to an insurance company for reimbursement.

It will be appreciated that that the above workflow is exemplary and the at the disclosed embodiments are applicable to workflows with more or fewer workflow components. Further, the sub-workflows 204, 206, 208, 210 may be performed during a single visit by the patient or over the course of multiple discrete time periods. For example, the patient intake 204, examination 206 and out-take 210 may be performed by a medical imaging facility while the diagnosis 208 may be performed by a remotely located radiologist.

Overall, the disclosed embodiments permit easier insight into procedures and offers an objective basis for discussion and improvement of the ways of proceeding, and display of a discovered solution in a simple way.

With respect to the exemplary workflow depicted in FIGS. 3-7, the overall workflow and the constituent workflow elements are visually represented in a simplified graphic manner which can be understood by all interested parties. These visual representations are clear and may be easily reviewed to identify inconsistencies, redundancies or other anomalies in the workflow which might otherwise be difficult to visualize. For example, the workflow may be reviewed to identify who is responsible for each workflow element and the results thereof, i.e. which actors are responsible for which activities and which artifacts. Further, workflow timing may be analyzed to determine at which time, i.e. which step of the workflow, a result/artifact is to be completed or another workflow element to be implemented. Both absolute and relative timing may be determined. Overall, the method yields a well adapted modus operandi for the workflow (“optimization effect”).

It is therefore intended that the foregoing detailed description be regarded as illustrative rather than limiting, and that it be understood that it is the following claims, including all equivalents, that are intended to define the spirit and scope of this invention.

We claim:

1. A method of modeling a clinical medical workflow, the method comprising:
identifying a plurality of workflow elements of the clinical medical workflow;
establishing at least one activity out of the plurality of workflow elements;
establishing at least one role out of the plurality of workflow elements;
establishing at least one artifact out of the plurality of workflow elements;
relating the at least one activity, the at least one role and the at least one artifact to define at least one relationship therebetween; and
generating a model comprising a representation of the clinical medical workflow based on the at least one activity, the at least one role, the at least one artifact and the at least one relationship.

2. The method of claim 1, further comprising:
generating a visual representation of the model, the visual representation visually identifying the at least one activity, the at least one role, the at least one artifact, the at least one relationship, or combinations thereof.

3. The method of claim 2, wherein the generating comprises converting the model to Hypertext Markup Language (“HTML”) and rendering the HTML using a browser program.

4. The method of claim 1, further comprising:
analyzing the model to identify any sub-optimal workflow elements of the clinical medical workflow.

5. The method of claim 4, further comprising:
optimizing the model to correct any identified sub-optimal workflow elements.

6. The method of claim 4, wherein the sub-optimal workflow elements include inefficient workflow elements.

7. The method of claim 4, wherein the sub-optimal workflow elements include redundant workflow elements.

8. The method of claim 4, wherein the sub-optimal workflow elements include inconsistent workflow elements.

9. The method of claim 1, wherein the clinical medical workflow comprises a medical procedure.

10. The method of claim 1, wherein the at least one activity comprises at least one action performed by at least one role.

11. The method of claim 1, wherein the at least one role comprises at least one entity that performs an action.

12. The method of claim 1, wherein the at least one artifact comprises one of an output generated by at least one role performing at least one action or an input received by at least one role performing at least one action based thereon.

13. A system for modeling a clinical medical workflow, the method comprising:
an interface operative to receive identification of a plurality of workflow elements of the clinical medical workflow;
first logic coupled with the interface and operative to establish at least one activity out of the plurality of workflow elements;
second logic coupled with the interface and operative to establish at least one role out of the plurality of workflow elements;
third logic coupled with the interface and operative to establish at least one artifact out of the plurality of workflow elements;
fourth logic coupled with the first logic, the second logic and the third logic and operative to relate the at least one activity, the at least one role and the at least one artifact to define at least one relationship therebetween; and
fifth logic coupled with the first logic, the second logic, the third logic and the fourth logic and operative to generate a model comprising a representation of the clinical medical workflow based on the at least one activity, the at least one role, the at least one artifact and the at least one relationship.

14. The system of claim 13, further comprising:
sixth logic coupled with the fifth logic and operative to generate a visual representation of the model, the visual representation visually identifying the at least one activity, the at least one role, the at least one artifact, the at least one relationship, or combinations thereof.

15. The system of claim 14, wherein the sixth logic is further operative to convert the model to Hypertext Markup Language (“HTML”) and rendering the HTML using a browser program.

16. The system of claim 13, further comprising:
sixth logic coupled with the fifth logic and operative to analyze the model to identify any sub-optimal workflow elements of the clinical medical workflow.

17. The system of claim 16, wherein the sixth logic is further operative to optimize the model to correct any identified sub-optimal workflow elements.

18. The system of claim 16, wherein the sub-optimal workflow elements include inefficient workflow elements.

19. The system of claim 16, wherein the sub-optimal workflow elements include redundant workflow elements.

20. The system of claim 16, wherein the sub-optimal workflow elements include inconsistent workflow elements.

21. The system of claim 13, wherein the clinical medical workflow comprises a medical procedure.

22. The system of claim 13, wherein the at least one activity comprises at least one action performed by at least one role.

23. The system of claim 13, wherein the at least one role comprises at least one entity that performs an action.

24. The system of claim 13, wherein the at least one artifact comprises one of an output generated by at least one role performing at least one action or an input received by at least one role performing at least one action based thereon.

25. A system for modeling a clinical medical workflow, the method comprising:
means for identifying a plurality of workflow elements of the clinical medical workflow;
means for establishing at least one activity out of the plurality of workflow elements;
means for establishing at least one role out of the plurality of workflow elements;
means for establishing at least one artifact out of the plurality of workflow elements;
means for relating the at least one activity, the at least one role and the at least one artifact to define at least one relationship therebetween; and
means for generating a model comprising a representation of the clinical medical workflow based on the at least one activity, the at least one role, the at least one artifact and the at least one relationship.
